(19) United States
(12) Patent Application Publication
(10) Pub. No.: US 2002/0119430 A1
(43) Pub. Date: Aug. 29, 2002

(54) Hypnotist referral network

(76) Inventor: Alexander Goen Szynalski, Randolph, NJ (US)

Correspondence Address: PHARMACEUTICAL PATENT ATTORNEYS, POHL & ASSOC. LLC, 55 MADISON AVENUE, 4TH FLOOR (P4014), MORRISTOWN, NJ, 07960-6397, US

(21) Appl. No.: 10/092,130

(22) Filed: Mar. 6, 2002

Related U.S. Application Data
(63) Continuation-in-part of application No. 09/427,447, filed on Oct. 27, 1999.

(51) Int. Cl. G09B 19/00

(52) U.S. Cl. 434/219

(57) ABSTRACT

A system for training and certifying hypnotists, and for referring patients to appropriately certified hypnotists for behavior modification therapy.

### I. CROSS REFERENCES

This application is a continuation in part of Ser. No. 09/427,447, now U.S. Pat. No. ______

### II. GOVERNMENT RIGHTS

None.

### III. BACKGROUND

In the parent patent application, I discuss behavior modification technology, and disclose how to make a behavior modification program most effective clinically. While this technology is effective, it is a somewhat significant departure from standard hypnosis practice. Thus, that technology remains less widely known and used than is optimally possible.

A problem encumbering the wide dissemination of that technology is the lack of a venue for training hypnosis practitioners. Publishing a book, a patent or a magazine article on the subject can teach a hypnosis practitioner the method. Simple publication, however, does nothing to assure potential patients—the consuming public—of the quality of the hypnotist's training. For example, if two hypnotists read a book on my technology, one hypnotist might understand the system completely, while the second hypnotist might fail to understand it at all, an example of the old saying, “a nod is as good as a wink, to a blind horse.” Thus, there is a need for a reliable, reproducible training process to train hypnotists in my technology, whereby the quality of the training offered to the hypnotist, and the level of understanding achieved by the hypnotist, will have a certain level of reliability to the consuming public.

Assuming there is a mechanism to reliably train hypnotists in my technology, there are several ways for the hypnotist to disseminate or advertise their achievement. The hypnotist could advertise in a Yellow Pages® advertisement, or on their business card or stationary, or purchase mass media advertising resources. Each of these venues is effective, albeit prohibitively expensive. This is because unlike the consumers of more traditional professional services (e.g., legal services, dental care services), with behavioral modification technology, the consumer (the patient) often is not familiar with—and thus does not understand the differences among—the various behavior modification technology available. Thus, a hypnotist advertising a given behavioral modification technology will be most productive if the hypnotist advertises not only the service vendor (the hypnotist), but also advertises and educates the consuming public about the particular service offered (the behavioral modification technology).

While advertising the specific service vendor may be affordable, advertising to educate the consuming public about a particular behavioral modification technology can be prohibitively expensive. This is because the individual hypnotist must underwrite advertising sufficient to educate the public at large. Further, a risk-taking innovator hypnotist who has the vision and courage to finance a large-scale advertising and educational campaign, is prey to copycats who “free ride” on the innovator's advertising effort. These copycats avoid contributing for the advertising required in the public-education process, yet profit from the greater public awareness, and court the same customers as does the risk-taking innovator.

### IV. SUMMARY

I have found a way to address all of these problems, by collecting a variety of elements into a new combination. My system involves providing hypnotist training courses together with a certification protocol to assure the quality of the hypnotist's comprehension of the training material. My system also involves storing contact information on certified hypnotists, and offering a central client referral “clearinghouse” that can both underwrite the advertising and consumer-education programs necessary to make behavioral modification technology more widely understood by consumers, and refer inquiring consumers to an appropriately certified, conveniently located hypnotist.

### V. THE DRAWINGS

FIG. 1 provides an overview of the process entailed in setting up and gathering preliminary data for my system.

FIG. 2 details my preferred version of the computer system [15].

FIG. 3 describes the process of receiving a new request for hypnosis services.

FIG. 4 describes the process of interviewing a potential patient to determine the most appropriate mixture of various kinds of intervention.

### VI. DETAILED DESCRIPTION

My currently-preferred version of my invention is illustrated in the enclosed Figures.

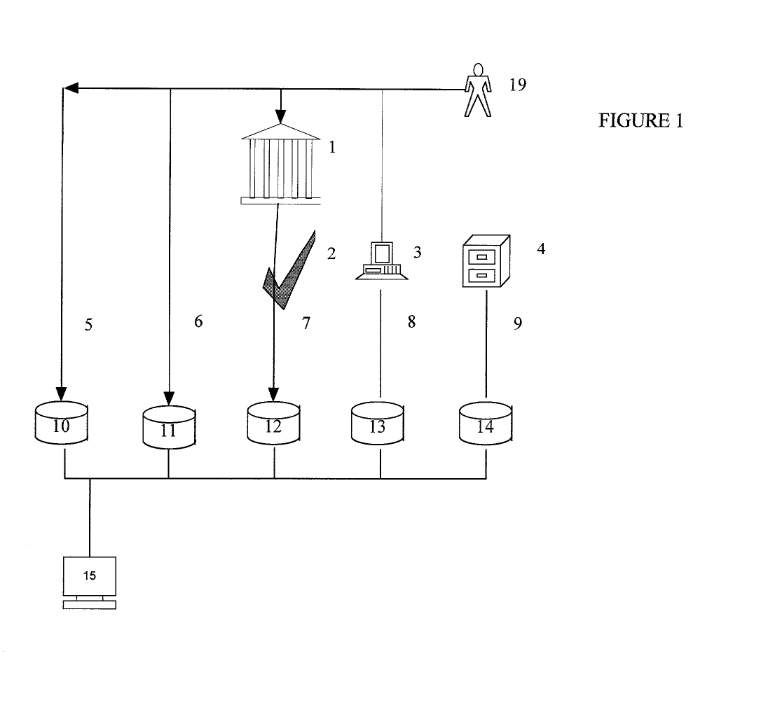

A. FIG. 1

FIG. 1 provides an overview of the process entailed in setting up and gathering preliminary data for my system. A hypnotist certification program [1] is a kind of school which offers an instructional course. This course teaches a hypnotist [19] in the various approaches I believe most effective for therapeutic intervention. As discussed more fully in the parent patent application, I believe it is most effective for therapeutic intervention to address three aspects of addictive behavior: the conscious mind, the unconscious mind, and the body. Thus, I prefer the hypnotist certification program [1] train the hypnotist [19] in the benefit of addressing all three of these areas, and teach specific techniques to address each of these three areas.

Thus, a hypnotist [19] enrolling in the certification program initially provides contact information [5] and agenda information [6]. Contact information is that information necessary or desirable to contact the hypnotist. It may include the hypnotist's telephone number, electronic mail address, facsimile number, street address, or any other information believed necessary. The only requirement is that the contact information include at least enough information to determine the physical location of the hypnotist. This may be simply by providing a telephone number, as the general location of a telephone number can be derived from the area code and three-digit telephone exchange included in the number, and the specific street address may be derived by using a “reverse telephone book” database which provides a street address for any given telephone number. The hypnotist's contact information [5] is stored in a contact information data structure [10a].

I prefer a system which can be used both with a hypnotist with a fixed geographic location (e.g., a fixed office), and with a hypnotist who travels from place to place, providing therapeutic intervention to patients located in a more broad geographic area. This is because sparsely-populated geographic areas may not have enough consumer demand or population to support a permanent hypnotist. These areas can be served, however, by a visiting hypnotist. The visiting hypnotist can physically visit the area and provide therapeutic intervention. Alternatively, the hypnotist may offer services virtually, as a “tele-medicine” provider, using the internet. For such a mobile hypnotist, the geographic area entry for them could be entered in the contact information database as, for example, “greater Cleveland,” or “Wisconsin,” or “North Midwest,” or “United States and Canada,” or “virtual” (for a tele-medicine provider).

The hypnotist also provides agenda information [6]. This information includes the times during which the hypnotist is available to take appointments to see a new patient. The hypnotist's agenda information [6] is stored in an agenda information data structure [11]. I prefer the agenda information allow for both precise times (e.g., every Monday from 2:30 to 4:00 p.m.) and for approximate times (e.g., the first week of every calendar quarter). For a tele-medicine hypnotist providing care over a network, the agenda could conceivably be “always.” Similarly, I prefer the agenda information data structure accept agenda data defined as an algorithmic function. This enables my system to calculate, for geographic areas where no hypnotist is permanently resident, when a physical visit by a hypnotist might be warranted. For example, for a sparsely populated area or small town served by a hypnotist located far away, the agenda data entry might be, “if and when at least seven patients in this geographic location request therapy.” In so doing, my system can schedule the hypnotist for a physical visit if and when there is enough consumer demand to justify the visit.

The hypnotist then attends the certification program [1]. At the end of the certification program, a test [2] may be administered. Alternatively, simply attending the certification program [1] may suffice to consider the hypnotist adequately trained in the given area. Regardless of approach, when the hypnotist is deemed adequately trained in the given area, the hypnotist is “certified” as such [2], and the hypnotist's certification information [7] is stored in a certification information data structure.

While my method may conceivably work with only one certification program [1], I prefer several certification programs to be offered. Thus, while certain fundamental therapeutic intervention techniques remain constant for various behavioral problems, each pattern of unhealthy behavior also is changed most effectively using intervention techniques specific for that behavioral pattern. Thus, I prefer to offer a certification program [1] in, for example, weight loss, another one in smoking cessation, another in maximizing athletic performance, another in healing “broken hearts” and building self esteem, and so forth and so on. Thus, as the hypnotist completes each specific certification program, the hypnotist will be certified [2] in that specific area—and that certification information [7] will be stored in a certification database [12]. Thus, a specific hypnotist may be “certified” for weight loss and for smoking cessation, and not certified for athletic performance nor for self-esteem building.

I prefer to supplement this data with several other data bases [13, 14]. One is a consumption database [13] containing algorithms to calculate the expected consumption of a product consumed by the patient as part of their therapeutic program. For example, a patient pursuing a smoking cessation program might be expected to use 90 capsules of a stop-smoking nutritional supplement every thirty days. Similarly, a patient pursuing a weight-loss program might be expected to use 120 capsules of a weight-loss nutritional supplement during the same time period. Alternatively, a patient attending athletic-performance optimization hypnosis might require a wrist band on starting the program, but nothing else subsequently. Such algorithms can be readily calculated [3] by the operator of the system based on the operator's past experience with various patient types and product types, and this historical data can be extrapolated to make predictive algorithms [9] which are then stored in the predicted consumption database [14].

Another type of data I prefer to include is a caller-ID database program and reverse-telephone book database [4]. Such programs are known in the art, and enable a telephone call recipient to determine the geographic location of a caller. This system can use caller-ID software to identify an outside caller's [17] telephone number using a call-source signal appurtenant to an incoming telephone call, and then use the caller's telephone number as a variable input in a reverse telephone book database, to determine the caller's [17] geographic location. This caller-location program [4] is stored [9] in a caller-location data structure [14].

The various data structures communicate such that a specific hypnotist's contact data, agenda data and certification data can be related, as data fields in a relational database, and sorted or retrieved based on the geographic location of a caller as determined by the caller-location program [4]. This may be accomplished by communicating them together as part of a computer system [15].

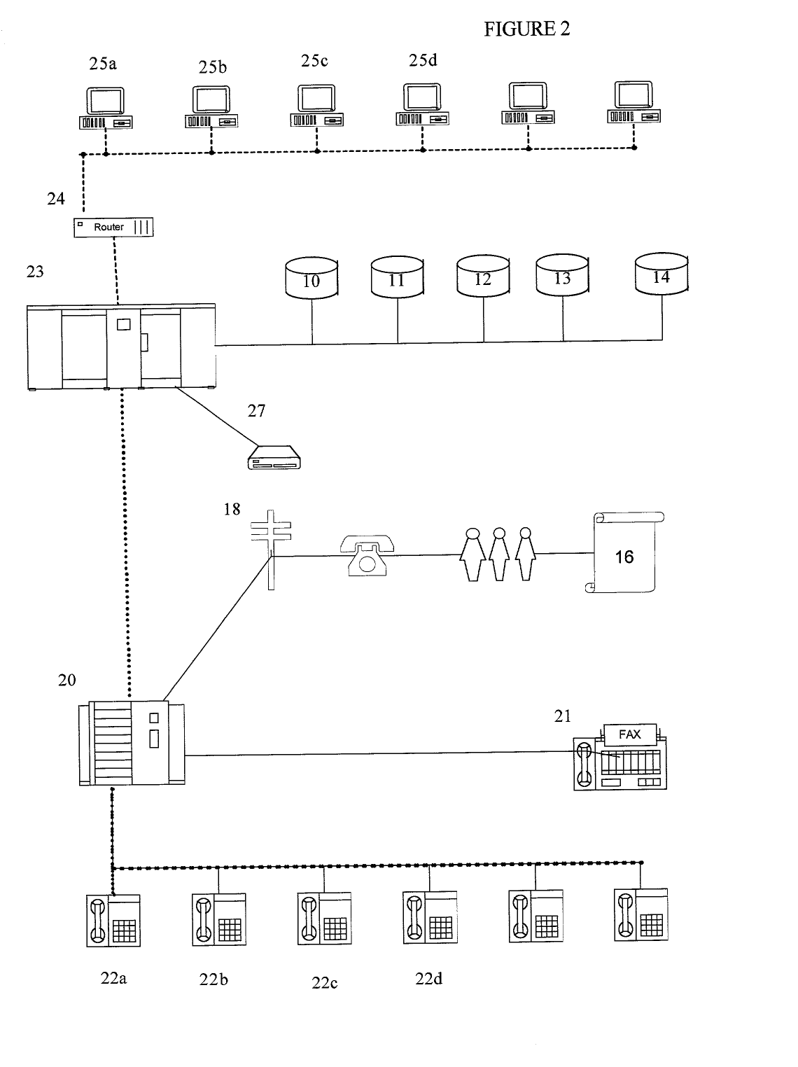

B. FIG. 2

FIG. 2 details my preferred version of the computer system [15]. The aforementioned databases [10, 11, 12, 13, 14] are accessible by a computer central processing unit [23] such as a mainframe computer or computer server. The central processing unit is in communication via a router [24] to a network (e.g., a local area network at a fixed facility, or a wide area network such as the Internet, enabling workers to work from home) having a plurality of computer terminals [25a, 25b, 25c, 25d, . . . ], each accessible by workers at a telephone sales call-center. Given a powerful enough and fast enough computer, the entire computer system [15] might be constructed on a single stand-alone personal computer, used by only one worker at a time. The computer central processing unit [23] also may have a modem, codec, cable modem or other external communications port or device [27].

The system also includes a telephone system, to receive and treat telephone calls. The base of the telephonic system may be a central PBX telephone switch [20], which in turn has a number of telephone sets [22a, 22b, 22c, 22d, . . . ] useable by the same workers who use the aforementioned plurality of computer terminals [25a, 25b, 25c, 25d, . . . ]. The telephone switch may also have a facsimile machine attached [21], to enable receipt of written facsimile transmissions such as credit card orders.

I illustrate the computer central processing unit [23] and the telephone switch [20] separately, for clarity. Commercially-available computer hardware and software, however, enables a computer central processing unit to act as the telephone switch [20].

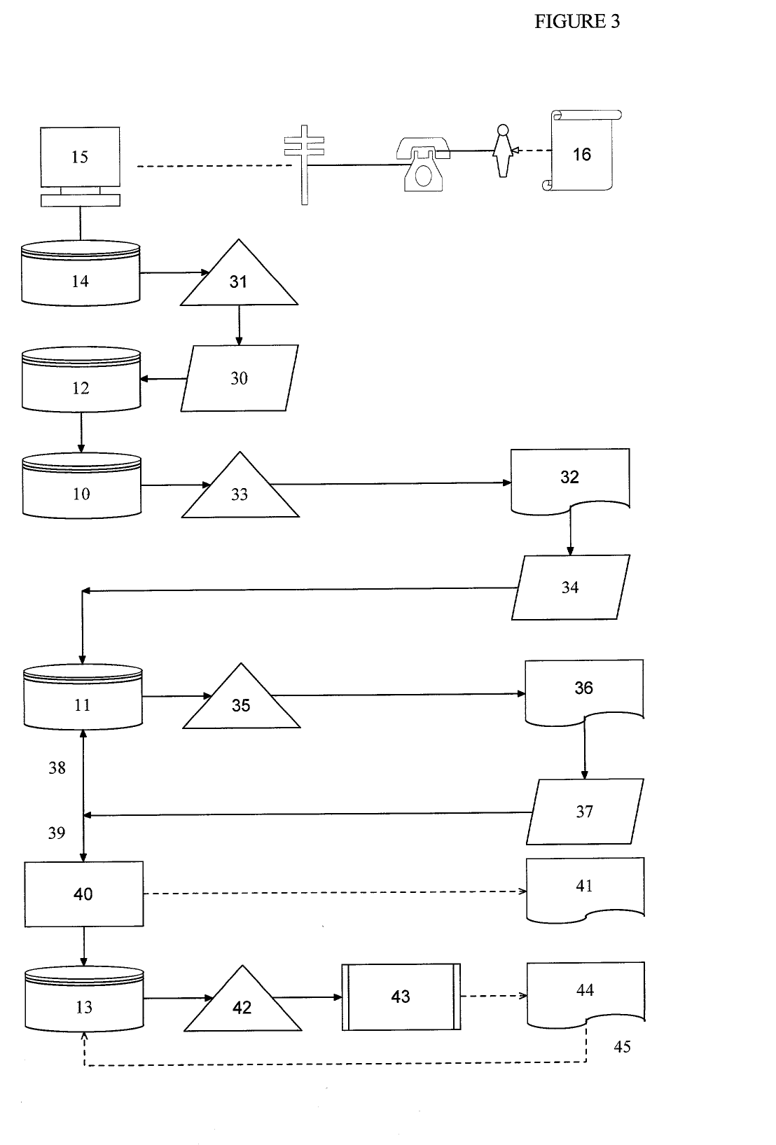

C. FIG. 3

FIG. 3 describes the process of receiving a new request for hypnosis services. In response perhaps to media advertising [16], a potential patient [17] calls the system operator, perhaps by calling an advertised toll-free “1-800” telephone number. The media advertising [16] can be of any type desired (e.g., broadcast radio, newspaper, direct mail). I prefer a combination of several types.

Specifically, I prefer to use, among other approaches, bulk purchase of “remnant” or surplus advertising inventory. That is, most media resources have, from time to time, unsold advertising space, which can be purchased at a deep discount if the advertiser's schedule is flexible. For example, a local newspaper might have, say, an average of 5,000 column-inches of advertising space available per day. Most days, the newspaper could go to press with 100% of this space sold in advance to advertisers, paying a market rate. Some days, however, there will inevitably be some amount of advertising space yet unsold as the newspaper goes to press. I prefer to purchase such space in advance, on an as-available basis, and pay for this left-over or remnant advertising space a discount price. This kind of space is appropriate for publishing, among other things, consumer-education content, which content is by its nature not particularly time sensitive.

Using surplus advertising space in conjunction with a flexible algorithm agenda data entry enables my system to provide the most sophisticated behavioral modification therapy, at the most cost-effective price, ever achieved in the history of behavioral modification services. Here is how it works.

Ads are published [16] using surplus media resources. These ads preferably discuss the advantages of behavioral modification therapy, but do not promise any definite time or place for therapy services. In response, potential patients call the system [15]. The potential patients' names, therapeutic need, and contact information are stored on a patient data base [10b]. The system monitors [46] the volume and timing of these inquiries. When sufficient interest is found, a hypnotist visit is scheduled for the area and the potential patients are contacted and notified [36] of the availability of hypnosis services in their area. Interested potential patients may then register for behavior modification therapy [37 et seq.] as more fully discussed elsewhere.

When the telephone call is received by the system [15], the caller-location program [14] identifies the caller's geographic location. I prefer this be done automatically and in the background, using the telephone caller's telephone number to retrieve the data [31] identifying the caller's geographic location. Alternatively (if, for example, the caller has their telephone number “blocked” and thus not locatable by the caller-location program [14]), a worker answering the telephone call could simply ask [30] the caller where they are calling from. This information is used to retrieve data [31] and identify hypnotists practicing in the caller's general geographic area.

As I mention above, I prefer my system be used to offer not just one hypnosis program, but a variety of them, for various needs (weight loss, smoking cessation, etc . . . ). Thus, the system must determine which program the caller wants. Various approaches avail. For example, the telephone switch [20] may provide a voice-mail menu we are all familiar with, asking the caller to “press 1 for smoking cessation, press 2 for weight loss,” and so forth. The caller's needs can thus be obtained [30] automatically. Alternatively, (if, for example, the caller does not have a touch-tone telephone), a worker answering the telephone call could simply ask [30] the caller what kind of program they are interested in. Alternatively, the step of obtaining this information [30] could entail a fairly lengthy or directed interview. Such an interview is discussed in more detail in FIG. 4, below.

In any case, the information obtained [30] on what kind of program the caller is interested in, is used to search the certification database [12] to retrieve data [33] identifying hypnotists certified in that particular subject area.

The data identifying what hypnotists practice in the callers geographic area [31] is sorted against the data identifying what hypnotists are certified in the desired subject area [33], to identify a hypnotist(s) who both practice in the caller's geographic area and are certified in the desired subject area. Data regarding the hypnotist(s) street address location(s) is output [32] so the caller can chose the location(s) most convenient. While this data output [32] can be done completely automated (e.g., using an automated voice mail response or an interactive on-line web-site), I prefer the more personal touch available by using a live telephone sales operator to do so.

In response, a choice [34] of a specific location is received from the caller. This data is used to sort the agenda database [11] to retrieve data [35] identifying the specific times available for therapy at that location. This data on specific times available [35] is output [36] so the patient can select [37] a time most convenient.

The patient's selection [37] is input into the system and used in two ways. The data is used to update [38] the agenda data structure [11] to indicate that the certain time is taken and thus no longer available. Similarly, the data is used as a variable input [39] in a reporting subroutine [40] that generates a report [41] to the hypnotist, telling them the identity of the patient, the time scheduled, and the subject area desired.

The patient's selection of a time to meet with the hypnotist may also be used for product inventory management. This is useful because certain types of hypnosis therapy are most effective when combined with ancillary products such as pharmaceuticals, nutritional supplements and the like. For example, smoking cessation therapy is most effective when combined with a stop smoking product to address the patient's symptoms of physical nicotine addiction. This stop smoking product might be a smoking cessation pharmaceutical (XYBAN®, commercially available from the Glaxo-Wellcome Company), a nicotine skin patch, or a nutritional supplement. A patient commencing a smoking cessation program may want or need these products ancillary to their hypnosis therapy. Thus, I prefer to use the agenda scheduling information as variable input [40] into the consumption database [13], which, as mentioned above, stores data [42] defining an algorithm to calculate [43] the estimated product requirements for the patient. Such product requirements are calculated [43] and output [44], preferably to the hypnotist. The results may be used to automatically ship product to the hypnotist. Alternatively, the results may be stored in [4] along with data on the hypnotist's prior intake and outlay of product, to maintain a current projected inventory for the hypnotist. In so doing, the hypnotist can assure that they have adequate inventory of product for the therapeutic intervention.

The ordering of these steps may be rearranged depending on the environment used to provide the system. For example, when using live telephone sales representatives, it is easiest to provide data on hypnotist location [32] first, and, after a specific hypnotist is selected, to then provide data on the hypnotist agenda [36]. When using an on-line system, however, both types of information may be provided simultaneously, allowing the patient to compare various available times for various geographic locations, to choose the most convenient.

D. Evaluative Interview

I will now elaborate on the step of obtaining information [31] from the prospective patient on their desired intervention. Note that in the claims, I refer to this procedure as a “diagnostic protocol,” while the specific protocol used is not necessarily a medical protocol (the one I prefer is not).

As I discuss in the parent patent application, behavioral modification is most effective when it addresses physical needs contemporaneously with mental (conscious and sub-conscious) needs. For a specific individual, however, at a specific point in their life, for a given specific behavioral issue, the relative importance of each of these three areas varies. For example, a specific smoker may be motivated to smoke 70% by the physical desire for nicotine and 30% by rote habit, and be largely ignorant of the medical effects of smoking. This person would benefit best by intensive use of a stop-smoking substance (XYBAN®, another pharmaceutical or nutritional supplement antidepressant, or a nicotine receptor antagonist) to address their physical urges, accompanied by some education and comparatively mild hypnotherapy (perhaps in a group setting rather than one-on-one intervention) to address their rote habitual behavior.

A different person, however, might smoke based on minimal physical urges, and a strong subliminal craving for emotional needs satisfied allegedly by smoking. This person would benefit most from less intense use of stop-smoking substances, and more intensive hypnotherapy, perhaps requiring one-on-one therapy rather than group therapy.

Given this continuum of potential individual needs, it is entirely possible that the caller may not know exactly what they need or want, in the way of therapeutic intervention. Thus, the caller might say, “I'd like a weight-loss one-on-one therapy.” Alternatively, the caller might say, “I want to lose weight. You tell me what I need to do to accomplish this.” In the latter instance, the step of obtaining information [30] on what kind of program is appropriate for the caller might entail interviewing the caller at some length, to more precisely identify the caller's behavioral profile and therapeutic needs, and to obtain a more accurate idea of the caller's relative need for physiological vis conscious vis unconscious intervention.

I have developed an interview protocol to do this profiling more effectively. It entails interviewing the potential patient to more clearly identify behavior patterns and possible physiological constraints.

An example of a script or framework for an interview such as this is as follows:

Do you find yourself craving foods that cause indigestion or even repeat on you? Do you find that you are always determined to clean all the food on your plate? Do you also find that, after you eat dinner and you are full, you continue to eat every so often, all the way until the time you go to bed, even though you know that you are physically full.

Let's repeat question number one: Do you find yourself craving foods that either cause indigestion or repeat on you? They answer yes. Analysis to that question is this: “Mrs. Jones, or Ma'am” you answered before that you find yourself craving foods that cause indigestion or even repeat on you. So, in other words, your body is physically rejecting that food but you are continuing to eat that food. What does that say? This could be a two-part problem. One part of that problem could be a physical problem. It could be that, physically, your digestive system is not functioning properly and as you get older your digestive system is certainly not nearly as effective. If that is the case, you want to make sure that you solve that challenge.

Number two, and probably more likely, is that you desire that food because you have been programmed to eat that food, psychologically, just like a cigarette smoker is programmed to smoke cigarettes. A cigarette smoker, the very first time that they smoked that cigarette, did not immediately love the way that it tasted. However, they were programmed that cigarette smoking is a happy, healthy, smart, cool, “in,” sexy thing to do.

“Mrs. Jones, did you know that there are three ways that your subconscious mind is programmed?” “Did you know, number one, that your subconscious mind dominates your thinking. Sigmund Freud said that your subconscious mind is kind of like an iceberg. It is composed of two parts: your conscious mind 10% and your subconscious mind 90%. Now, if your conscious mind wants one thing and the subconscious mind wants something else, which part do you think normally wins? Yes, that 90% of your mind! Your subconscious mind may be saying to you, “I love that food!” But your conscious mind and your body, physically, are rejecting it. So what you want to do is to find out if this is a psychological or physiological issue.

Question two that I asked you in reference to this subject matter was: You indicated that you always find yourself eating all the food on your plate. So, if you eat all the food on your plate, is that a signal that you are eating until you are physically full or a signal that you are eating until you are psychologically full? For example, if you are eating until you are physically full, you either stop with food still on your plate, or you would finish your plate, then get more food and stop with food left on your plate. So it is clearly an indication of you ignoring the physiological signal and paying attention to a psychological signal. Why is that? I am willing to bet, “Mrs. Jones,” that one or two things happen. Number one, is it that your Mom, or your Dad, you probably can blame your Mom more, suggested that you clean all the food on your plate and then you will get a reward. Or, clean all the food on your plate because of all the starving children in Africa who have no food. You were told this over and over and over again. By the way, lesson number two about the subconscious mind is that it is programmed using repetition. Anything it hears over and over and over again it eventually begins to believe. “This seems to be the case here, isn't it, Mrs. Jones?” By the way, lesson number three about the subconscious mind is that the subconscious mind wants to take you towards pleasure and wants you to stay away from pain. If your Mom suggested that you get a treat, a reward, at the end of your dinner, this is an example of using that pleasure principle. So you have been programmed this way.

Then you also answered another question which was that you often find yourself, after you have finished dinner, eating small meals all the way until you go to bed. Now, if you just finished dinner, you cannot possibly be physiologically hungry! That is totally psychological.

You may be eating psychologically for many, many reasons and it is important to find out exactly why and then determine if your weight problem is more of a psychological weight problem or more of a physiological weight problem, or both and that you may need a two-prong approach. We would like to suggest to you that you take ten minutes and finish this ______ questionnaire with us to determine a specific plan of attack to finally becoming fat-free and fabulously fit forever.

“Dear Mrs. Jones, we are not just physiological beings, we are not just psychological beings, we are both and in order to achieve prominent weight loss and be fat-free and fabulously fit forever it is important that you treat all the symptoms. If you leave one out, the likelihood is that you will not have long-term success. You will probably have many temporary successes that turn into failures where you lose the weight but then you put even more back on and again lose the weight and put even more on. Every time you lose the weight and put it back on again, you lose fat and muscle at the same time but you gain more fat back and less muscle. You don't want this to happen to you, do you Mrs. Jones?” She replies, “No, I don't.” “Okay, I do want to remind you that we talked about this before that your mind is basically programmed in three ways.”

One thing about the subconscious mind is that it dominates your thinking; it is 90% of your mind. Number two, it is programmed using repetition. Anything your subconscious mind hears over and over and over again, it is eventually going to believe as in the case of a compulsive, degenerate liar actually eventually beginning to believe their very own lies.”

Number three, your subconscious mind behaves for two reasons: it tries to take you towards pleasure and wants you to stay away from pain. So, now we are going to start this physiological/psychological analysis.

1. How much do you weigh?

2. Do you find yourself craving something sweet right after you eat a meal? For example, do you want to have cake or a dessert?

3. Do you find when you desire to become fat-free and fabulously fit forever, you say “I need to lose ______ weight.” Or do you tell people that you lost weight?

4. Do you find that you work in an environment that uses fluorescent light or do you watch television in the dark?

5. When you are hungry, do you find yourself mentally saying to yourself, “I'm hungry, I'm starving, or do you say, “I'm so hungry, I could eat a horse, a cow or whatever?”

6. Do you find yourself eating within an hour after waking up in the morning?

7. Do you eat for reasons other than being physically hungry? For example, when you are worried, bored or when you are watching television?

8. How many servings of fruits and vegetables do you eat a day?

9. When you close your eyes and imagine what you look like, is the image of what you see an overweight image? Or one of a thin fit person?

10. Do you exercise at least three times a week?

11, While eating dinner, do you find yourself watching television at the same time?

12. Do you drink eight to ten glasses of water a day?

“Okay, Mrs. Jones, thank you for that evaluation. Now, let me tell you what we have learned and discovered about you.” In question number one, we asked you how much you weigh. You replied 190 pounds. Earlier, we asked what your current weight is and you said it was 190 pounds. We have psychologically discovered that you are taking ownership of the weight that you currently weigh. You must psychologically take ownership of the weight that you want to weigh, not the weight that you are currently. Normalcy is very important to the subconscious mind. If your subconscious mind believes that the weight which you currently weigh is your normal weight, then it is going to attempt to keep you at that “so-called normal” weight.

The second question we asked was, “Do you crave something sweet after you eat? Typically, you may crave sweets for two reasons. One reason is that you have been programmed that if you clean your plate, you get your dessert. It could be psychological but it could also very well be physiological. If you physically have that sugar craving, it may be nothing more than when you eat something, your pancreas produces insulin, which in turn digests blood sugar, which in turn give you an energy boost. If you eat something sweet, your pancreas produces large amounts of insulin. You may actually be craving that sweetness because you are craving that large amount of insulin to be produced. However, this is very unhealthy. It causes the membrane in the muscle cell to be resistant to insulin, causing complications and number two, insulin is a hormone that causes your body to store fat. Of course, this is not your objective.

Question three was, “Do you refer to weight reduction as losing weight? You answered, “Yes.” We are programmed all day long that when you lose something, it is painful. You lose an idea, thought, piece of jewelry or money. When you find something, it is pleasurable. We do this numerous times a day, lose ideas, find ideas. Someone says to you, “My gosh, it looks like you lost weight.” Your subconscious mind says, “Wow, I've just lost something, I better go find it again.” It is very damaging to lose weight if you want to finally become fat-free and fabulously fit forever.

Next question was, “Do you find yourself doing a lot of activities, such as watching television in the dark or working in a fluorescent environment?” You answered yes. This is physically very unhealthy because we have a gland in our brain called the penal gland which basically produces two hormones; one is serotonin which increases energy level and decreases appetite and the other one, melatonin, which decreases energy level and increases appetite. If you find yourself doing activities in dark environments or even in a fluorescent environment, where fluorescent light is not recognized by the penal gland like normal sunlight, there is a tendency of producing more melatonin, slow down your metabolism and causing additional physical cravings for foods.

The next question that you answered, when referring to being hungry, you often will say, “I'm starving or I'm so hungry, I can eat a whatever.” Typically, when you analyze the self-talk that most overweight people use on themselves, it is very damaging. You can directly correlate the quality of your life to the quality of your self-talk. If you look at overweight people and what they say to themselves, versus thin people and what they say to themselves, it is very different. An overweight person will say “I'm starving,” which would indicate that there is a strong psychological challenge that has to be addressed and also that a strategy must be implemented to correct that very damaging psychological self-talk that you are using on yourself.

Next was do you eat breakfast within an hour after you wake up and you indicated, “No.” Breakfast studies have shown that, physically, it sets your metabolism for the day. Many people will say, “Yes, but if I eat breakfast, I find myself more hungry at lunch.” Typically, that is a physical hunger. One of the first signs of a healthy animal is that they have a good appetite. A healthy human being does have a good appetite and they eat at normal intervals all day long. A person that does not do this, is found to be more psychologically challenged and they eat at the psychological times that they have been programmed are important to eat. This is a very strong indication that there is a psychological issue here.

You had indicated that you eat often when you are worried, watching television, depressed or bored. If this is the case, it is a strong indication that you are not listening to your body telling you that you are physically full. You are paying more attention to the psychological fullness, what the subconscious, that 90% of your brain, tells you is the proper thing to do. This must, of course, be addressed.

Typically, you had indicated that you eat ______ servings of fruits and vegetables a day. If you are not eating the proper amounts of fruits and vegetables a day, it indicates that physically you are probably not getting the proper nutrients. You need to either start eating those fruits and vegetables or you take some sort of supplement to compensate for this discrepancy.

You had indicated that your self-image, what you mentally think about when you imagine yourself, is one of an overweight person. If this is the way you believe you are, the likelihood is that it is the way you are going to be. If you change the image that you have of yourself and you imagine yourself as a thin person, then you will use your mind, that 90% of your subconscious mind which is incredibly powerful, to help you achieve that fat-free and fabulously fit look.

You had indicated that you do not exercise three times a week. In order to be fat-free and fabulously fit forever, exercise plays a major role. You may not be exercising because your energy level is too low or because psychologically you do not find exercising enjoyable. It is important that exercise is approached from both parts. Part number one, taking the proper nutrients so you have a good, healthy energy level and secondly, that you psychologically have programmed yourself to believe that exercise is a pleasurable experience for yourself.

You had answered that you find yourself watching television or maybe even doing other activities while eating. When you do this, you are really more focused on what is on the television than listening to your body telling you that you are physically full. Studies have shown that you actually physically eat less if, while eating, you either do it in a quiet environment or in an environment with relaxing music. However, if it is an environment with lots of stimulation, you will ignore your body physically telling you that you are full and you will depend more on the psychological part of it. This is an important issue to address.

You stated that you are not drinking eight to ten glasses of water a day. We have a part of our brain called the hypothalamus; we also call it the weight-regulating mechanism. Its job is to perceive feast and famine. If it perceives famine, it slows down metabolism. If it perceives feast, it speeds up your metabolism. If you are walking around dehydrated all day long, your hypothalamus perceives more of a famine than a feast and, of course, it slows down your natural metabolic rate. It increases your sub-point, which is a pre-determined weight that your hypothalamus considers to be safe, normal and effective for you.

E. Synopsis

While I prefer my system to be practiced using a telephone call center staffed with live operators, one may do the same thing in a variety of ways. For example, I prefer certain data [e.g., 30, 34], be obtained from, and provided to, a patient using the personal touch available with live telephone sales representatives. One could replace live sales representatives with a responsive voice mail menu or an interactive on-line menu on a web-site. These alternatives are less expensive to operate that paying sales representatives, albeit may provide less customer satisfaction than a live sales representative.

Similarly, while I prefer the system be used with the specific smoking cessation behavioral modification technology discussed in the parent patent, the system might just as easily be used with other behavioral modification technology. All that is required is a standard training and certification program as described by the claims.

Throughout this patent and the appended claims, I use the singular to allow for one or more of the object.

While I discuss various examples of my system here, I use these as examples only, and modifications will become familiar to those of skill in the art. Thus, I intend this patent to cover the system as encompassed by the claims appended here and their equivalents.

I claim:

1. A method comprising:
Maintaining a data base of certified hypnotist contact data,
Receiving an inquiry from a potential hypnosis patient,
Searching said data base of certified hypnotist data, and
Providing said potential hypnosis patient certified hypnotist contact data.

2. The method of claim 1, further comprising:
Providing to a hypnotist a training program,
Assessing said hypnotist against a pre-determined certification parameter,
If said hypnotist meets said certification parameter, certifying said hypnotist and storing said certified hypnotist contact data in said data base.

3. The method of claim 1, wherein:
Said data base further comprises certified hypnotist agenda data, and
Said potential hypnosis patient is provided said certified hypnotist agenda data.

4. A method comprising:
Maintaining a data base of certified hypnotist contact data,
Receiving from a potential hypnosis patient contact data,
Searching said data base of certified hypnotist data,
Identifying in said data base a certified hypnotist, and
Sending to said certified hypnotist said potential hypnosis patient contact data.

5. The method of claim 4, further comprising:
Providing to a hypnotist a training program,
Assessing said hypnotist against a certification parameter,
If said hypnotist meets said certification parameter, certifying said hypnotist and storing said certified hypnotist contact data in said data base.

6. The method of claim 4, wherein:
Said data base further comprises certified hypnotist agenda data, and
Said potential hypnosis patient is provided said certified hypnotist agenda data.

7. A method comprising:
Purchasing remnant advertising media,
Publishing in said remnant advertising media an advertisement for behavioral modification therapy, and
Receiving patient contact data from a potential patient.

8. The method of claim 7, further comprising:
Contacting said potential patient regarding the availability of behavioral modification therapy.

9. A system comprising:
A hypnotist training program,
A pre-determined hypnotist certification parameter,
A data base of certified hypnotist contact data,
A potential patient inquiry receiver, and
A data base search engine.

10. The system of claim 9, said data base further comprising certified hypnotist agenda data.

11. A system comprising:
Means for purchasing remnant advertising media,
Means for publishing in said remnant advertising media an advertisement for behavioral modification therapy, and
Means for receiving patient contact data from a potential patient.

12. The system of claim 11, further comprising:
Means for contacting said potential patient regarding the availability of behavioral modification therapy.

13. A method comprising:
Providing to a potential patient a diagnostic protocol addressing physical and psychological parameters,
Receiving from said potential patient a response to said diagnostic protocol,
Based on said response, allocating to said potential patient physical behavioral modification intervention factors and psychological behavioral modification intervention factors.
